(19) United States
(12) Patent Application Publication
(10) Pub. No.: US 2007/0174906 A1
(43) Pub. Date: Jul. 26, 2007

(54) System and Method for the Secure, Transparent and Continuous Synchronization of Access Credentials in an Arbitrary Third Party System

(75) Inventors: Chris Burchett, Lewisville, TX (US); Warren Robbins, Celina, TX (US); Jason Jaynes, Austin, TX (US); Brijesh K. Mishra, Wylie, TX (US)

Correspondence Address: HAYNES AND BOONE, LLP, 901 MAIN STREET, SUITE 3100, DALLAS, TX, 75202, US

(73) Assignee: Credant Technologies, Inc., Addison, TX (US)

(21) Appl. No.: 11/560,301

(22) Filed: Nov. 15, 2006

Related U.S. Application Data
(60) Provisional application No. 60/736,887, filed on Nov. 15, 2005.

(51) Int. Cl. G06F 17/30

(52) U.S. Cl. 726/8

(57) ABSTRACT

This present invention provides a system and method making it possible for a third party add-on system to keep user authentication credentials synchronized with an existing user authentication mechanism.

### CROSS-REFERENCE TO RELATED APPLICATIONS

The present application claims priority to U.S. Provisional Patent Application No. 60/736,887, titled “System and Method For Secure Transparent Continuously Synchronized Credentials in an Arbitrary Third Party System,” filed Nov. 15, 2005.

### FIELD OF THE INVENTION

The present invention relates generally to data security and, more particularly, to a method and system for maintaining synchrony of user access credentials in systems with layered security applications.

### BACKGROUND OF THE INVENTION

Desktop and notebook personal computers, along with PDA's and smartphones, have become indispensable tools for business and home use. Portable devices, e.g., notebook computers, PDA's and smartphones are popular business tools. Sensitive company and personal information is routinely stored on the hard disk drives within these devices. This sensitive information may include login information for banks and corporate systems as well as account numbers and other information necessary to use these systems. Storing such information on devices is commonly required for the operation of business both in corporations and at home. However, the need to store this information often creates a serious risk of identity theft if the device is lost or stolen and the information is not protected. For this reason, there is a significant need to protect the information stored on devices.

The expectations for protecting information stored on these devices are quite simple—ensure that only authorized users are permitted access to sensitive information stored on or systems accessible by the device. In pursuit of this end, it is common for IT system administrators to employ the resources of one or more add-on, third-party or supplemental security applications layered on top of any security provided by the operating system or first line of defense of the device. These add-on, third party or supplemental security application layers are commonly sourced from a provider different from that of the operating system or first line/layer of defense. For example, provider W may provide the operating system or first layer of defense for a device and the data thereon, while providers X, Y and Z, typically unrelated to one another and provider W, may provide additional, potentially overlapping, layers of security for all or a portion of the data and resources of the device.

In operation, these add-on, third party or supplemental security applications may be configured to secure one or more portions of the device on which they are deployed, e.g., each add-on or third party security application may be configured to protect only those portions of the device or data specifically associated with the add-on or supplemental security application. In an alternative implementation, these add-on, third party or supplemental security applications may be configured to secure the device and the data stored thereon in their entirety. Further, it is possible that these add-on, third party or supplemental security applications may be configured to secure a device or data somewhere between these two extremes, potentially including the same data or device portions within the protection of more than one layered security application.

Typically, before an add-on, third party or supplemental security application can unlock that portion or data of the device for which it is responsible, the add-on, third party or supplemental security application will attempt to perform its own user authentication. In some implementations, this attempted authentication may be performed following a grant of access to the device by the authorization mechanism of the operating system or first line of defense, with the add-on, third party, or supplemental security application separately prompting the user for the provision of access credentials for use and authentication by the add-on, third party or supplemental security application. In other implementations, the add-on, third party or supplemental security application may be configured to receive those user access credentials received and authenticated by the operating system or first security layer.

In the latter method, synchrony between the user access credentials of the operating system or first layer of security and the one or more add-on, third party or supplemental security applications is critical. Should user access credentials for the operating system and the add-on, third party or supplemental security layers become unsynchronized, a user may be granted access by the operating system or first layer of defense only to then be denied access to those portions of the device or that data protected by the add-on, third party or supplemental security layer due to the add-on, third party or supplemental system's inability to authenticate the user with the user access credentials provided by the operating system or first line of security. Such a result will have a significant affect on the usefulness of the device and can severely impact productivity, not to mention user experience.

### SUMMARY OF THE INVENTION

In view of the existing shortcomings of the prior art, a few of which are mentioned above, one embodiment of the present invention provides a method including prompting a user for one or more access credentials, receiving one or more user provided access credentials, authenticating the user provided access credentials in an existing authentication server, forwarding authenticated user provided access credentials to an add-on authentication client associated with at least one third party component operable to protect one or more portions of a client system, making a first attempt to authenticate the forwarded authenticated user provided access credentials with an add-on authentication server and unlocking one or more portions of the client system protected by the third party component in response to authentication of the forwarded authenticated user access credentials with the add-on authentication server.

Further, teachings of the present invention provide method including receiving forwarded authenticated user provided access credentials by an add-on authentication client associated with at least one third party component operable to protect one or more portions of a client system, making a first attempt to authenticate the forwarded authenticated user provided access credentials with the add-on authentication client's locally stored third-party credentials by hashing the forwarded authenticated user provided access credentials to obtain a hash result, decrypting a root key using the has result, comparing a hash value to ensure the root key was properly decrypted, and unlocking one or more portions of the client system protected by the third party component in response to authentication of the forwarded authenticated user access credentials using the locally stored third-party credentials.

In another aspect, teachings of the present invention provide a system including at least one microprocessor, at least one memory operably associated with the at least one processor and a communications interface operably associated with the at least one processor and operable to exchange information through one or more communications media. In addition, the system may further include an add-on authentication client storable in the memory and executable in the processor, the add-on authentication client operable to receive user access credentials authenticated by an existing authentication client, attempt to authenticate the received user access credentials with at least one of an add-on authentication server or cached user accessed credentials, unlock one or more portions of the system protected by an associated third party component, in response to authentication of the user access credentials with at least one of the add-on authentication server or the cached credentials, send a credential challenge to the add-on authentication server in response to a failure to authenticate the received user access credentials, receive a credential response, attempt to authenticate the credential response, and unlock a portion of the system protected by the associated third party component upon authentication of the credential response.

Teachings of the present invention further provide a method for secure transparent continuously synchronized credentials in an arbitrary third party system including receiving a credential update notification, retrieving a challenge code and a device identification, sending the challenge code and device identification to a credential and authentication manager, retrieving an encrypted root key associated with the device identification, generating a response code using the challenge code and root key, transmitting the response code to a client credential and authentication manager, verifying correctness of the response code by decrypting the root key associated with the device identification, and updating the one or more access credentials.

In a further aspect, teachings of the present invention provide a method for maintaining synchronization between user access credentials required by an existing authentication client and an add-on authentication client including receiving at the add-on authentication client one or more user access credentials authenticated by at least one of an existing authentication client or an existing authentication server, attempting to authenticate the user access credentials at the add-on authentication client, conducting a challenge with an add-on authentication server communicatively associated with the add-on authentication client in response to a failure to authenticate the user access credentials by the add-on authentication client, and updating one or more user access credentials accessible by the add-on authentication client upon successfully completing the challenge with the add-on authentication server.

In one aspect, teachings of the present invention may provide a method and system for maintaining synchrony between user access credentials required to gain general access to a device as well as those required to gain access to one or more device resources protected by one or more add-on, third party or supplemental security applications layered on top of those provided by an operating system or first layer of security, regardless of the source of such add-on, third party or supplemental security application layers.

In another aspect, teachings of the present invention may enable the secure updating of user access credentials in an add-on, third party or supplemental security application when such user access credentials are changed in the operating system or one or more other layers of security.

In still another aspect, teachings of the present invention generally do not require user access credentials of the add-on or supplemental security application layer to remain accessible after authentication in order to update them when they change in the operating system or other existing authentication resources.

In a further aspect, teachings of the present invention may be implemented such that the process of maintaining synchrony between user access credentials of an operating system or existing authentication resources and any add-on authentication resources is transparent to end-users, including the update of user access credentials in an add-on authentication resource when a user updates their access credentials in an existing authentication resource layer such as the operating system.

Additional advantages may be appreciated in view of foregoing as well as the one or more embodiments of the invention described and claimed below.

### BRIEF DESCRIPTION OF THE DRAWINGS

A more complete understanding of the present embodiments and advantages thereof may be acquired by referring to the following description taken in conjunction with the accompanying drawings wherein:

FIG. 1 is a block diagram illustrating one embodiment of an information handling system according to teachings of the present invention;

FIG. 2 is a block diagram illustrating one embodiment of a series of systems leveraged by and implementing teachings of the present invention;

FIG. 3 is a block diagram illustrating one embodiment of a method for maintaining credential synchrony between an existing authentication mechanism and an add-on, arbitrary third party system according to teachings of the present invention; and

FIGS. 4-8 are flow diagrams illustrating one embodiment of a method for maintaining credential synchrony between an existing authentication mechanism and an add-on, arbitrary third party system incorporating teachings of the present invention.

The present invention may be susceptible to various modifications and alternative forms. Certain embodiments of the present invention are shown by way of example in the drawings and are described herein. It should be understood, however, that the description set forth herein of certain embodiments is not intended to limit the present invention to the particular forms disclosed. Rather, all modifications, alternatives and equivalents falling within the spirit and scope of the invention as defined by the appended claims are intended to be covered.

### DETAILED DESCRIPTION

Certain preferred embodiments and their advantages may be best understood by reference to the accompanying figures and the description contained herein. In some instances, the same or similar reference symbols in the different figures may be used to indicate the same or similar items.

For purposes of this disclosure, an information handling system, computer or similar device may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

As referred to herein, a component of an information handling system may assume a variety of forms. In one aspect, a component of an information handling system may include, but is not limited to, a single hardware device such as a hard drive, floppy disk drive, CPU, or removable media. In another aspect, a component of an information handling system may include, but is not limited to, a single software module such as the software pertaining to data protection, system virtual memory or display management. Further, a component of an information handling system may include a plurality of hardware devices, a plurality of software modules, or a combination of hardware devices and software modules.

Teachings of the present invention, in one embodiment, are designed to protect a heterogeneous mobile computing environment comprised of notebooks, tablet PCs, PDAs and smartphones from a wide variety of manufacturers using varied operating systems, including, without limitation, Windows®, Palm®, Windows Mobile®, RIM BlackBerry®, Symbian and others. The description that follows is primarily directed to reliably accessing vital information securely stored on notebooks, tablet PCs, PDAs, and desktops or other information handling or computing systems. However, the following description is not intended to limit the scope of the present invention.

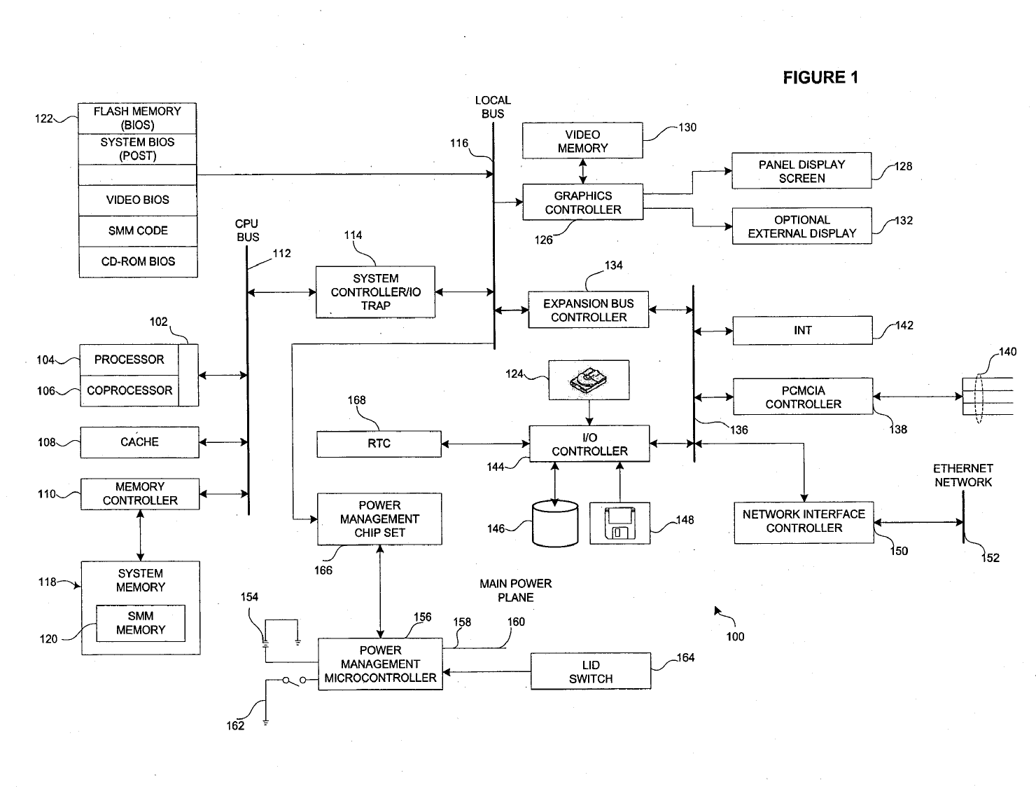

Referring first to FIG. 1, a block diagram of an information handling system is shown, according to teachings of the present invention. Information handling system or computer system 100 preferably includes at least one microprocessor or central processing unit (CPU) 102. CPU 102 may include processor 104 for handling integer operations and coprocessor 106 for handling floating point operations. CPU 102 is preferably coupled to cache 108 and memory controller 110 via CPU bus 112. System controller I/O trap 114 preferably couples CPU bus 112 to local bus 116 and may be generally characterized as part of a system controller.

Main memory 118, dynamic random access memory (DRAM) modules, for example, is preferably coupled to CPU bus 112 by a memory controller 110. Main memory 118 may be divided into one or more areas such as system management mode (SMM) memory area 120.

Basic input/output system (BIOS) memory 122 is also preferably coupled to local bus 116. Flash memory or other nonvolatile memory may be used as BIOS memory 122. A BIOS program (not expressly shown) is typically stored in BIOS memory 122. The BIOS program preferably includes software operable to facilitate interaction with and between information handling system 100 devices including, but not limited to, a keyboard (not expressly shown), mouse (not expressly shown), or CD-ROM 124. BIOS memory 122 may also store system code operable to control a plurality of basic information handling system 100 operations.

Graphics controller 126 is preferably coupled to local bus 116 and to display screen 128. Graphics controller 126 may also be coupled to a video memory 130 operable to store information to be displayed on display 128. Display 128 is preferably an active matrix or passive matrix liquid crystal display (LCD). However, other display technologies may be employed. In selected applications, uses or instances, graphics controller 126 may also be coupled to an optional, external or standalone monitor display 132.

Bus interface controller or expansion bus controller 134 preferably couples local bus 116 to expansion bus 136. In one embodiment, expansion bus 136 may be configured as an Industry Standard Architecture (“ISA”) bus. Other buses, for example, a Peripheral Component Interconnect (“PCI”), PCI-Express, Universal Serial Bus (USB), FireWire®, may also be used.

Personal computer memory card international association (PCMCIA) controller 138 may also be coupled to expansion bus 136 as shown. PCMCIA controller 138 is preferably coupled to a plurality of expansion slots 140. Expansion slots 140 may be configured to receive PCMCIA expansion cards such as modems, fax cards, communications cards, or other input/output (I/O) devices as well as other components.

Interrupt request generator 142 is also preferably coupled to expansion bus 136. Interrupt request generator 142 is preferably operable to issue an interrupt service request over a predetermined interrupt request line in response to receipt of a request to issue interrupt instruction from CPU 102.

I/O controller 144, often referred to as a super I/O controller, is also preferably coupled to expansion bus 136. I/O controller 144 preferably interfaces to an integrated drive electronics (IDE) or other compatible hard disk drive 146, CD-ROM (compact disk-read only memory) or other optical media drive 124 and floppy disk or other removable media drive 148. Other disc drive devices (not expressly shown) which may be interfaced to the I/O controller include, without limitation, a removable hard drive, zip drive, CD-RW (compact disk-read/write) drive, CD-DVD (compact disk-digital versatile disk) drive, DVD-RW, Flash memory, and USB fob drives.

Network interface controller 150 is preferably provided and enables information handling system 100 to communicate with communication network 152, e.g., an Ethernet network. Communication network 152 may include a local area network (“LAN”), wide area network (“WAN”), Internet, Intranet, wireless, wireless broadband or other communication network. Network interface controller 150 preferably forms a network interface for communicating with other information handling systems (not expressly shown) coupled, wirelessly or otherwise, to communication network 152. An information handling system's communication components generally include hardware as well as software components. Examples of hardware components include network interface controller 150 and communication network 152. Examples of software components include messaging services and network administration services.

As illustrated, information handling system 100 preferably includes power supply 154, which provides power to the many components and/or devices that form information handling system 100. Power supply 154 may be a rechargeable battery, such as a nickel metal hydride (“NiMH”) or lithium ion battery, when information handling system 100 is embodied as a portable or notebook computer, handheld device, PDA, smartphone, etc.

Power supply 154 is preferably coupled to power management microcontroller 156. Power management microcontroller 156 preferably controls the distribution of power from power supply 154. More specifically, power management microcontroller 156 preferably includes power output 158 coupled to main power plane 160 which supplies power to CPU 102. Power management microcontroller 156 may also be coupled to a power plane (not expressly shown) operable to supply power to display 128.

Power management microcontroller 156 is preferably also coupled to main power switch 162, which the user may actuate to turn information handling system 100 on and off. While power management microcontroller 156 powers down one or more portions or components of information handling system 100, e.g., CPU 102, display 128, or hard drive 146, when not in use to conserve power, power management microcontroller 156 itself is preferably substantially always coupled to a source of power, preferably power supply 154.

In a portable embodiment, information handling system 100 may also include screen lid switch 164 or indicator 164 which provides an indication of when display 128, when implemented as a movably coupled display, is in an open position and an indication of when display 128 is in a closed position. It is noted that display 128 may be located in the same location in the lid (not expressly shown) of the computer as is typical for “clamshell” configurations of portable computers such as laptop or notebook computers. In this manner, display 128 may form an integral part of the lid of the system, which swings from an open position to permit user interaction to a closed position. Other configurations are contemplated including, without limitation, tablet PCs and PDAs.

Computer system 100 may also include power management chip set 166. Power management chip set 166 is preferably coupled to CPU 102 via local bus 116 so that power management chip set 166 may receive power management and control commands from CPU 102. Power management chip set 166 is preferably connected to a plurality of individual power planes (not expressly shown) operable to supply power to respective components of information handling system 100, e.g., hard drive 146, removable media drive 148, etc. In this manner, power management chip set 166 preferably acts under the direction of CPU 102 to control the power supplied to the various power planes and components of a system.

Real-time clock (RTC) 168 may also be coupled to I/O controller 144 and power management chip set 166. Inclusion of RTC 168 permits timed events or alarms to be transmitted to power management chip set 166. Real-time clock 168 may be programmed to generate an alarm at a predetermined time as well as to perform other operations.

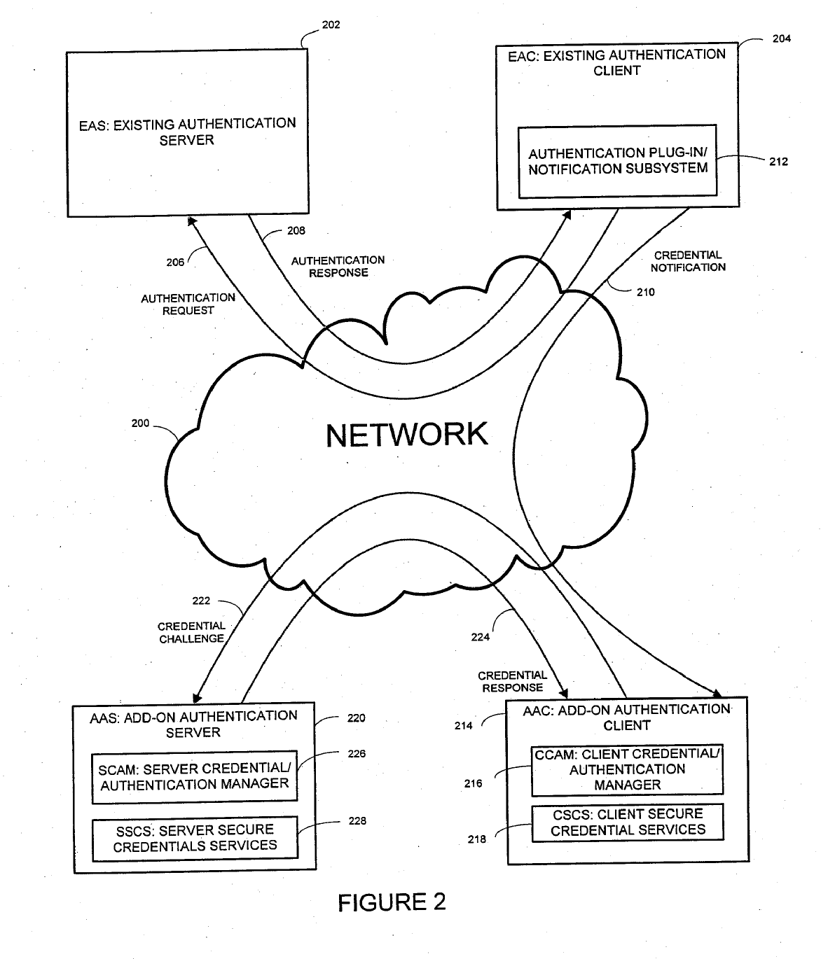

Referring now to FIG. 2, a high-level, contextual diagram of one embodiment of the present invention is shown. Each of the components in FIG. 2 is shown communicatively coupled to network 200 which may include one or more wireless and/or wireline technologies as well as one or more related and/or disparate “sub” networks making up the whole. The remaining components of FIG. 2 are described in greater detail below.

As shown in FIG. 2, an existing authentication server (EAS) 202 may be provided in one embodiment of the present invention. In one aspect, EAS 202 may serve as the ultimate enforcer of passwords. For example, attempts to authenticate access to network or other computing resources may go through EAS 202. In a Windows environment, for example, EAS 202 may be a Windows Domain Controller. Other operating system, network and related applications are contemplated by teachings of the present invention.

In addition to EAS 202, existing authentication client (EAC) 204 is preferably included in an embodiment of the present invention. In response to receipt of an access/login request, for example, EAC 204 may prompt a user for entry of one or more client access credentials before attempting to send authentication request 206 to EAS 202. If EAC 204 is able to communicatively connect to EAS 202, authentication response 208 may be received by EAC 204. Without authentication response 208, in one embodiment, EAC 204 may use cached credentials to attempt to authenticate the user provided client access credentials, restrict access by the client or take other desired actions. EAC 204 preferably includes Authentication Plug-in/Notification subsystem 212. In operation, Authentication Plug-in/Notification subsystem 212 preferably provides a notification 210 to one or more add-on or third party components at a minimum, for login, logout and update credential events. In a Windows system, EAC 204 may be a Windows workstation. As mentioned above, other software environments are also contemplated.

Also provided in a preferred embodiment of the present invention is add-on authentication client (AAC) 214. According to teaching of the present invention, AAC 214 may be a third party software security component. One purpose of AAC 214, according to teachings of the present invention, is to receive authentication notifications 210 from EAC 204 and to unlock all or portions of the system protected by the add-on or third party security component or layer. In one instantiation, the Credant Mobile Guardian (CMG) Shield may be leveraged to perform this and other functions.

Still referring to FIG. 2, client credential and authentication manager (CCAM) 216 may also be included in an embodiment of the present invention. CCAM 216 may be implemented as a software module within AAC 214. In one embodiment, CCAM 216 may receive and process login, logout and update credential notifications from EAC 204. CCAM 216 may be configured to process less or additional operations. CCAM 216 preferably includes higher level logic used to implement add-on security authentication functions such as login, logout and update credentials using, for example, CSCS 218.

In addition to CCAM 216, client secure credential services (CSCS) 218 may also be included in an embodiment of the present invention. Similar to CCAM 216, CSCS 218 may be implemented as a software module within AAC 214. Preferably, CSCS 218 provides secure storage of credentials and cryptographic services necessary to lock, unlock and/or update security parameters (e.g., identifiers, encryption keys, integrity checksums, etc.) In general, CSCS 218 may be leveraged to provide one or more low level services used by CCAM 216.

As shown in FIG. 2, add-on authentication server (AAS) 220 may also be incorporated in an embodiment of the present invention. According to teachings of the present invention, AAS 220 may be implemented as a third party software component. In one aspect of the present invention, AAS 220 may be employed to securely receive credential challenges 222 from AAC 214 and to compute credential response 224. In one instantiation, the Credant Mobile Guardian (CMG) Enterprise Server may perform this and other functions.

Server credential and authentication manager (SCAM) 226 may also be included in one embodiment of teachings of the present invention. In one embodiment, SCAM 226 may be a software module within AAS 220 operable to receive and process credential update challenge requests from CCAM 216 within AAC 214. SCAM 226 preferably contains higher level logic used to compute credential update responses using SSCS 228. Once the response is computed, SCAM 226 preferably sends the computed credential response 224 to CCAM 216.

Assisting one or more of the aforementioned components of an embodiment of the present invention, server secure credential services (SSCS) 228 may be provided. In one embodiment, SCS 228 may be a software module implemented within AAS 220. According to teachings of the present invention, SSCS 228 may provide the cryptographic primitives necessary to generate and securely store security parameters (e.g., identifiers, encryption keys, integrity checksums, etc.). In general, SSCS 228 may be leveraged to provide low level services used by SCAM 226.

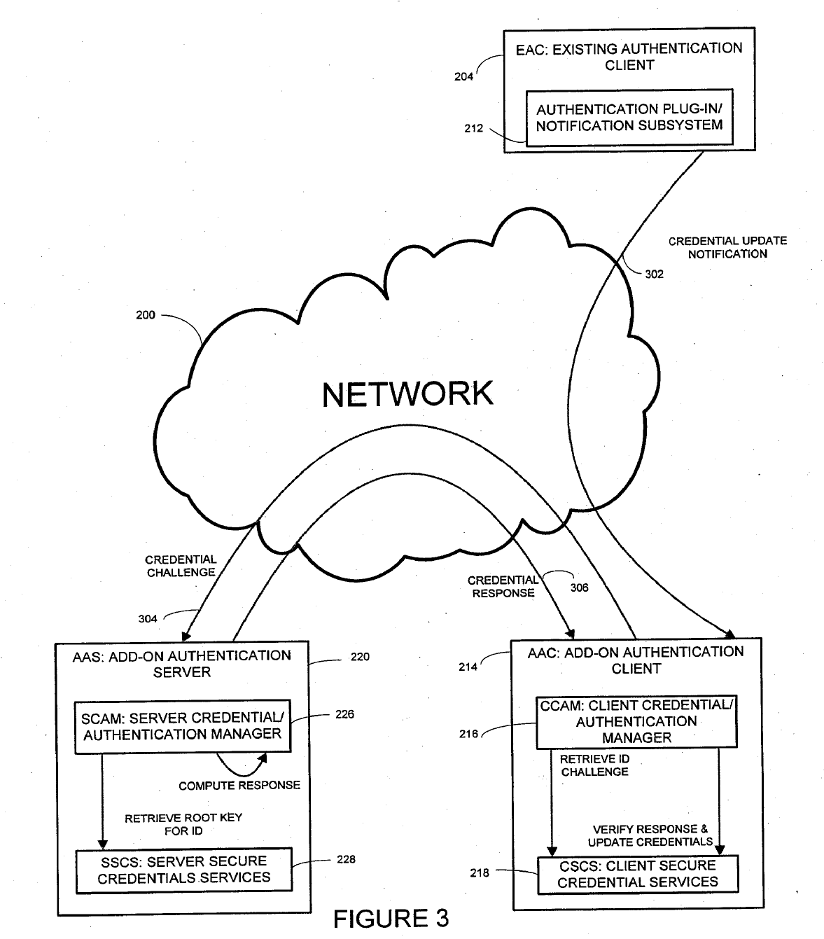

Illustrated in FIG. 3 is one embodiment of a method for securely and transparently updating user access credentials in an arbitrary third party system leveraging components of FIG. 2. According to teachings of the present invention, the workflow of FIG. 3 preferably enables a third party or add-on security system to keep one or more user based authentication or access credentials (e.g., a password) synchronized with an existing user authentication mechanism, e.g., a Windows login. In the embodiment of the present invention depicted in FIG. 3 and described generally herein, a password change applied from EAC 204 to AAC 214 is shown.

As shown in FIG. 3, EAC 204 may transmit a credential update (e.g., a password change) notification 302 to AAC 214. Within AAC 214, CCAM 216 preferably receives credential update notification 302. Following receipt, CCAM 216 will preferably retrieve a challenge code and a device-id and/or user-id from CSCS 218. Once obtained, CCAM 216 will preferably send credential challenge 304 (e.g., challenge code and device-id) to SCAM 226 in AAS 220.

Generally next, SCAM 226 will preferably retrieve a root key associated with the device-id and/or user-id from SSCS 228. SCAM 226 may then use the challenge code and root key to generate a response code. Having generated a response code, SCAM 226 will then preferably send credential response 306 (e.g., the response code) to CCAM 216.

Following receipt of the credential response, CCAM 216 preferably passes all or a portion of credential response 306 received from SCAM 226 and the updated credentials received from EAC 204 to CSCS 218. CSCS 218 may then authenticate or verify the correctness or validity of the received information. Following authentication or verification of the received information, CSCS 218 may unlock the credentials and update the system's stored credentials, thereby maintaining synchrony between the user's client access credentials at EAC 204, AAC 214, AAS 220 and/or EAS 202.

The above workflow embodiment includes certain assumptions. Specifically, the workflow above assumes that AAC 204 and AAS 202 both have a shared secret, e.g., a root key. This shared secret may be established at initialization, or at some other appropriate or convenient time. The workflow further preferably assumes that AAC 214 generate and store a challenge code. Such a challenge code may be generated at initialization or at another time. In one embodiment, the challenge code may be generated during each subsequent usage of the challenge/response code.

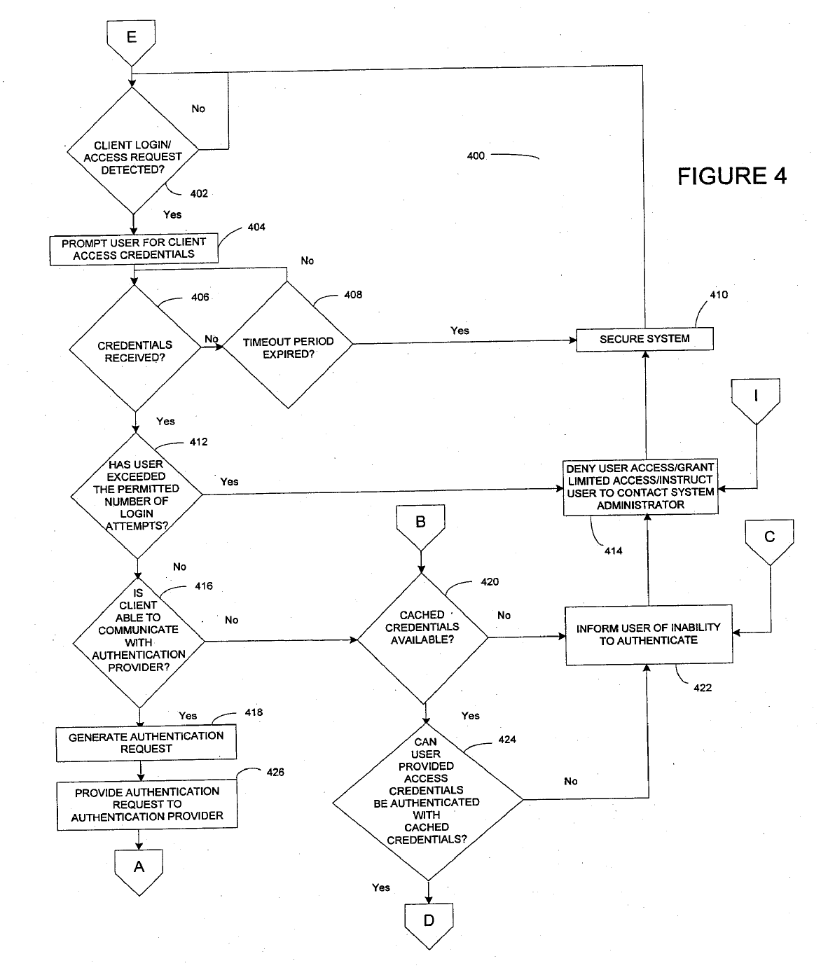

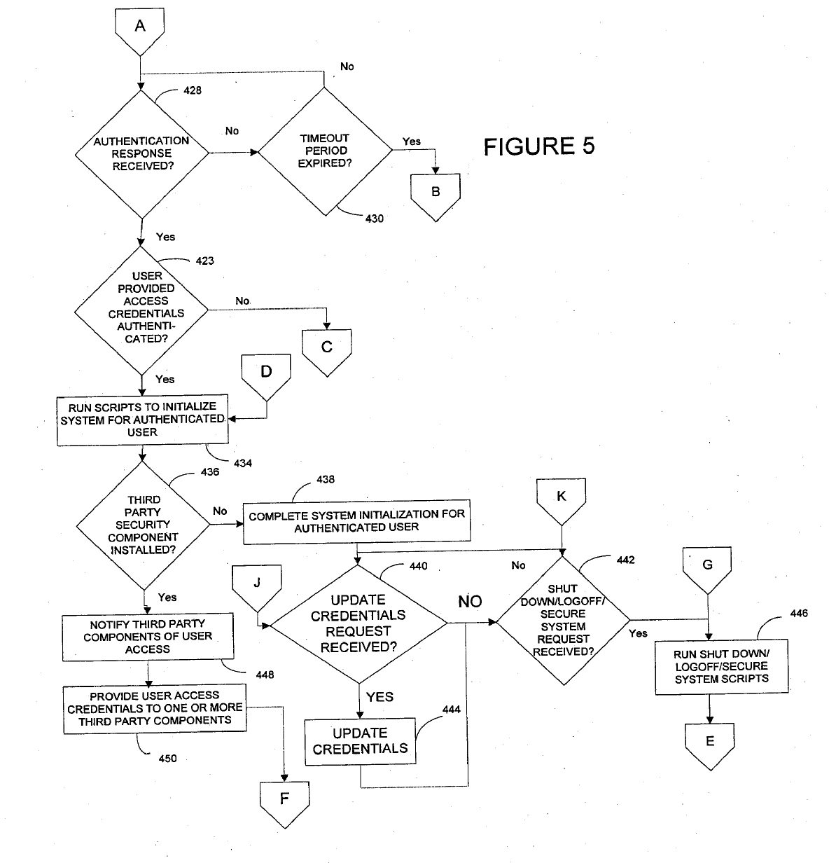

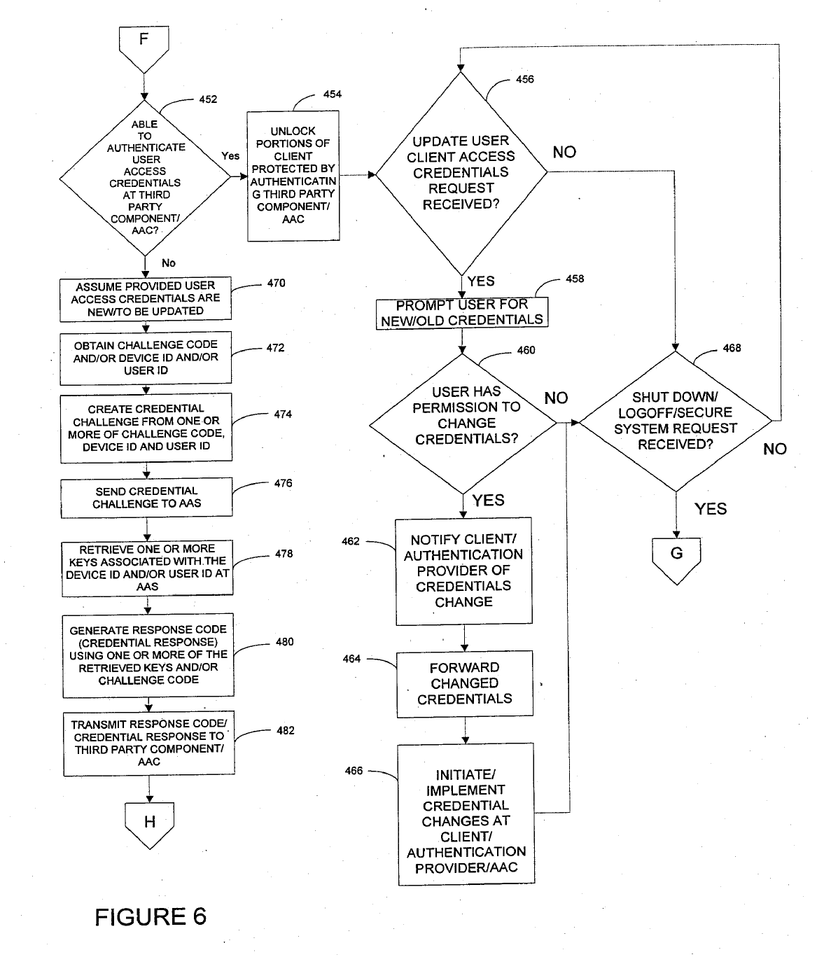

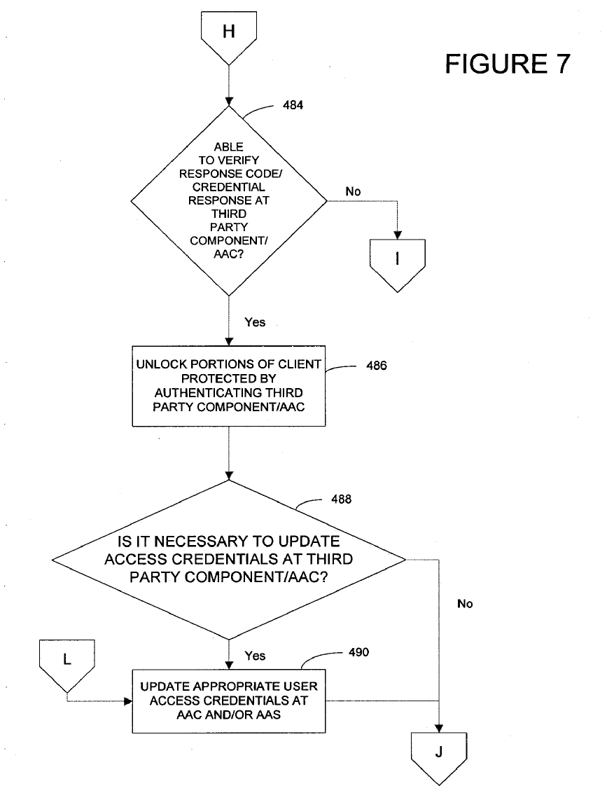

Referring now to FIGS. 4-7, one embodiment of a method incorporating teachings of the present invention is show. According to teachings of the present invention, method 400 may be implemented in a Windows environment, i.e., EAS 202 and EAC 204 may implement one or more Windows® based products. However, teachings of the present invention are not limited to such systems. Instead, teachings of the present invention may be utilized with any system configured to provide baseline, frontline or some other form of first or initial layer of security, e.g., login authorization, to one or more clients, networks, or other computing resources or data.

As illustrated in FIGS. 4-7, in operation, method 400 preferably provides for the monitoring of an EAC for access attempts. In method 400, for example, an EAC may be monitored at 402 for a client login/access request. If a client login/access request is not detected at 402, method 400 preferably remains at 402 awaiting such an event. Other operations may be performed in response to an idle or waiting system, including timing out or powering down the EAC after a certain period of inactivity. Still other operations may be performed in response to an inactive or waiting EAC.

If at 402 a client login/access request is detected, method 400 preferably proceeds to 404 where the EAC, leveraging one or more operating components thereof, preferably prompts the login/access requesting user for their client access credentials. It should be noted that while the discussion herein makes reference to client access credentials, such should not be considered a limitation to the teachings of the present invention. In fact, teachings of the present invention may be used with respect to access to server, mainframe, network, data or any other computing component credential.

Following the prompting of a user for their client access credentials, method 400 preferably proceeds to 406. At 406, the EAC preferably monitors its one or more input devices and system resources to determine whether the user has provided the EAC with their client access credentials. If at 406 client access credentials are not detected as having been received, method 400 preferably proceeds to 408 where an EAC system timeout period is preferably checked. If the EAC timeout period has not expired, method 400 preferably returns to 406 where the entry of one or more user provided client access credentials may again be checked. In contrast, if at 408 it is determined that the EAC timeout period has expired, method 400 preferably proceeds to 410 where the EAC may be secured before returning to 402 to await a user login/access request.

If at 406 it is determined that a user has entered their client access credentials, method 400 preferably proceeds to 412. At 412, a check may be performed to determine whether a permitted number of login/access attempts for the EAC have been exceeded. As is known, limiting the number of attempts that may be performed at a client may be implemented to prevent hackers from entering a variety of login/access credentials in an effort to breach the security of a given system. Other security measures may also be placed into method 400 here or at other points. If at 412 it is determined that the permitted number of login/access attempts for the EAC have been exceeded, method 400 preferably proceeds to 414 where a user may be denied access, granted limited access, instructed to contact a system administrator or otherwise informed that access has not or can not be granted. Following the desired notification of the user, access denial, or other action at 414, method 400 preferably proceeds to 410 where operation may proceed generally as described above.

However, if at 412 it is determined that the permitted number of login/access attempts has not been exceeded, method 400 preferably proceeds to 416 where it may be determined whether the EAC sought to be accessed is communicatively coupled to an authentication provider, e.g., an EAS or other network, computing resource, data authentication mechanism or system. If the EAC is able to communicate with an authentication provider, method 400 preferably proceeds to 418.

If at 416 the EAC is unable to communicate with an associated authentication provider, method 400 preferably proceeds to 420 where the EAC may determine whether it maintains cached credentials with which it may attempt to authenticate the user provided client access credentials. If the EAC does not maintain cached credentials or does not maintain cached credentials for the current user attempting to login to or access the EAC, method 400 preferably proceeds to 422. At 422, the user is preferably informed of the EAC's inability to authenticate the user's client access credentials before proceeding to 414 where operation may proceed generally as described above.

If at 420 is it determined that the EAC does maintain cached credentials, method 400 preferably proceeds to 424. At 424, the EAC will preferably determine whether the user provided client access credentials can be authenticated using the cached credentials. For example, the EAC may simply compare the user provided client access credentials against those maintained by the EAC. Other methods of authenticating user provided client access credentials are contemplated within the spirit and scope of the present invention. If at 424 the EAC is unable to authenticate or verify the user provided client access credentials with credentials maintained by the EAC, method 400 preferably proceeds to 422 where operation may proceed generally as described above.

As introduced above, if at 416 it is determined that the EAC is able to communicate with an authentication provider, method 400 preferably proceeds to 418 where the EAC will preferably generate an authentication request. Following generation of an authentication request at 418, method 400 preferably proceeds to 426 where the EAC will preferably provide, forward or otherwise communicate the generated authentication request to an associated authentication provider, e.g., the EAS to which the EAC is communicatively coupled.

Following communication of the authentication request from the EAC to an authentication provider, method 400 preferably proceeds to 428 where it may be determined whether an authentication response from the authentication provider has been received by the EAC. If at 428 it is determined that an authentication response form the authentication provider has not been received, method 400 preferably proceeds to 430 where a determination may be made as to whether an authentication response waiting time period has expired. If the authentication response waiting time period has not expired, method 400 preferably returns to 428 where receipt of an authentication response may be awaited. If at 430 it is determined that the authentication response time period has expired, method 400 may proceed to 420 for operations generally as described herein.

Once an authentication response is received by the EAC, method 400 may proceed to 432 where a determination regarding whether the user provided client access credentials have been authenticated may be made. If at 432 it is determined that the user provided client access credentials could not be authenticated with the authentication provider, method 400 may proceed to 422 for operation generally as described above.

If the user provided client access credentials were authenticated at either 424 or 432, method 400 preferably proceeds to 434 where one or more base client or system initialization scripts may be run to ready the client for use by the authenticated user. Following initialization of base scripts at 434, method 400 preferably proceeds to 436 where one or more aspects of the client may be interrogated to determine whether the client has installed thereon one or more add-on, third party, or supplemental security components, e.g., Credant Mobile Guardian or other arbitrary, third party security application layers.

If at 436 it is determined that the EAC does not include any third party security components, method 400 may proceed to 438 where initialization of the EAC may be completed. Following initialization of the EAC for use, the EAC may go into a mode of monitoring for events such as a user request to update their client access credentials at 440 or a user request to shut down, logoff, or secure the EAC at 442. If at 440 no user request to update or change their client access credentials is received, method 400 may proceed to 442 to determine whether a shut down, logoff or secure system request is received. Method 400 may perform the operations at 440 and 442 while the EAC is otherwise in use.

Alternatively if at 440 it is determined that an authorized user would like to update or modify their client access credentials, method 400 may proceed to 444 where one or more processes directed to enabling the user to update or modify their client access credentials may be executed. For example, the EAC may prompt the user for their new credentials as well as their old credentials before proceeding with the update or modification, determine whether the user is authorized to change such credentials, etc. If at 442 it is determined that a user seeks to shut down, logoff or secure the EAC, method 400 preferably proceeds to 446 where one or more shut down, logoff or secure system scripts may be executed in fulfillment of the user request before proceeding to 402.

If it was determined at 436 that one or more third party security components are installed on the EAC, such third party components, for example, having their own user authentication procedures in place, method 400 preferably proceeds to 448 where each of the third party security components is preferably notified of the received user client access request. Following notification of the user client access request at 448, method 400 preferably provides for the delivery of the user provided client access credentials at 450 before proceeding to 452.

At 452, an add-on authentication client (AAC) of the third party security component will preferably attempt to authenticate the user provide client access credentials. In one embodiment, the attempt to authenticate the user provided client access credentials by the AAC may involve the AAC comparing the user provided client access credentials against credentials maintained by the AAC or third party security component. In an alternate embodiment, the attempt to authenticate the user provided client access credentials by the AAC may involve the AAC contacting a communicatively coupled add-on authentication server (AAS) for authentication. In still another embodiment, the attempt to authenticate may include hashing the received credentials and using the result to decrypt a root key before comparing a hash value to ensure that the root key was decrypted properly. If at 452 the AAC is able to authenticate the user provided client access credentials, method 400 preferably proceeds to 454 where the third party security system and/or the AAC will preferably unlock those portions of the client it is designated to protect.

Following the unlocking of those portions of the client for which the third party security component or AAC are responsible at 454, method 400 preferably proceeds to 456 where the client is monitored for receipt of an update user access credentials request. If an update user access credentials request is received, method 400 preferably proceeds to 458 where the requesting user may be prompted for their old access credentials, e.g., for security purposes, and for their desired updated user access credentials. Once the user's existing and desired updated access credentials are obtained, method 400 preferably proceeds to 460 where a determination may be made as to whether the user has the appropriate permissions to update or modify their access credentials.

If it is determined at 460 that the user indeed has the appropriate permission to update or modify their access credentials, method 400 preferably proceeds to 462 where the client system and/or the authentication provider may be notified of the user access credentials change request before the update user access credentials are provided to the same at 464. At 466, changes to the existing user access credentials are preferably initiated and/or implemented at the client, authentication provider and/or the AAC.

Method 400 may reach 468 from at least from a determination at 456 of no received request to update user access credentials, a determination at 460 that the user lacks the permission needed to change their user access credentials or following initialization or implementation of the requested changes to a user's access credentials at 466. At 468, method 400 preferably monitors the EAC for receipt of a request to shut down, logoff or secure the EAC. If such a request is not detected, method 400 may monitor the EAC by returning to 456. If such a request is received, method 400 preferably proceeds to 446 for operation generally as described herein.

If the AAC is unable to authenticate the user provide client access credentials at 452, method 400 may proceed to 470 in one embodiment. In such an embodiment, method 400 method 400 may treat the received user provided client access credentials are credentials to be updated with the AAC. Following operations at 470, or in an embodiment where the assumption provided at 470, method 400 preferably proceeds to 472.

At 472, the AAC may obtain a challenge code and/or a device identifier and/or a user identifier. From the challenge code and/or a device identifier and/or a user identifier, the AAC preferably creates a credential challenge at 474. The credential challenge is then preferably communicated to the AAS at 476.

At the AAS, upon or after receipt of the credential challenge, one or more keys associated with the device identifier and/or user identifier is preferably retrieved at 478. From the retrieved one or more keys, e.g., one or more root keys, a response code or credential response using the one or more retrieved keys and/or the challenge code may be generated at the AAS at 480. Once a credential response has been generated, the credential response is preferably transmitted to the AAC or third party security component at 482 before method 400 preferably proceeds to 484.

At 484, the AAC or third party security component preferably determines whether the credential response received from the AAS can be verified or authenticated. If not, method 400 preferably proceeds to 414 for operations generally as described above. However, if at 484 the AAC is able to verify the credential response received from the AAS, method 400 preferably proceeds to 486 where those portions of the EAC for which the third party security component are responsible may be unlocked.

Following the granting of access to those portions of the EAC protected by the third party security component, method 400 preferably proceeds to 488 in one embodiment. At 488, a determination may be made as to whether it is necessary or desirable to update the user provided client access credentials the AAC was unable to verify or authenticate at 452. If it is determined at 488 that the user's client access credentials do not need to be updated, method 400 may proceed to 440 for operations generally as described above. Alternatively, if it is determined that existing user client access credentials do need to be update, method 400 preferably proceeds to 490 where the appropriate user client access credentials may be updated or modified at the AAC, AAS, EAC and/or authentication provider. Following the operations at 490, method 400 preferably proceeds to 440 for operations generally as described above.

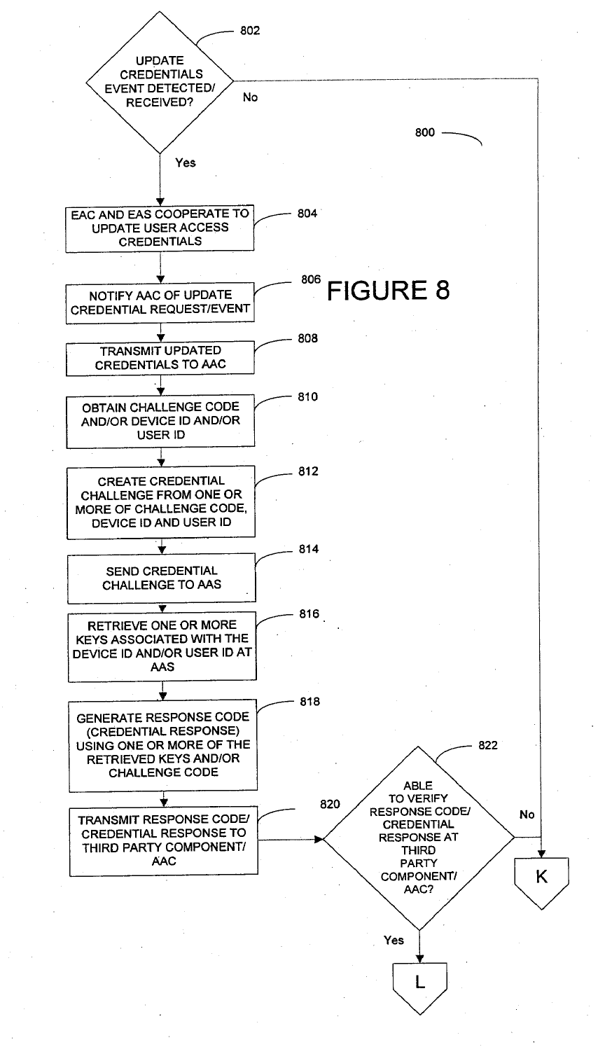

Referring now to FIG. 8, a flow diagram illustrating one embodiment of a supplemental or replacement routine for one or more portions of the method illustrated in FIGS. 4-7 is depicted according to teachings of the present invention. In general, method 800 of FIG. 8 depicts one embodiment of a routine or method for handling update credential events in a system incorporating teachings of the present invention.

In one embodiment following user authentication completion through the unlocking of those portions of the EAC protected by third party security components, method 800, at 802, preferably provides for the monitoring of the EAC for a user request to update one or more of their access credentials. If no update credential events are detected, method 800 may proceed to 442 for operations generally as described above. However, if at 802 there is detected an update credentials event, method 800 preferably proceeds to 804.

At 804, the EAC and EAS, for example, preferably cooperate to update one or more user client access credentials as requested by the user. At 806, the AAC is preferably notified of the received update credentials event. The updated user credentials are preferably transmitted or otherwise provided to the AAC at 808. Once the AAC has possession of the updated credentials, method 800 preferably initiates a challenge between the AAC and AAS at 810 to 820 generally as described above with respect to method 400 at 472 to 484. At 822 of method 800, if the AAC is able to verify the credential response received from the AAS, method 800 preferably proceeds to 490 for operations generally as described above. Alternatively, if at 822 the AAC is unable to verify the credential response received from the AAS, method 800 preferably proceeds to 442 for operations generally as described above.

The description above is exemplary and is not intended to limit the teachings of the present invention in any manner. For example, one or more the modules describe above may be further combined and the operations distributed among a number of additional components. Further, one or more portions of the invention described herein may be implemented in hardware, software or some combination thereof.

Although the present disclosure has been described in detail, it should be understood that various changes, substitutions, and alterations can be made hereto without departing from the spirit and the scope of the invention.

What is claimed is:

1. A method, comprising:
receiving forwarded authenticated user provided access credentials by an add-on authentication client associated with at least one third party component operable to protect one or more portions of a client system;
making a first attempt to authenticate the forwarded authenticated user provided access credentials with the add-on authentication client's locally stored third-party credentials by hashing the forwarded authenticated user provided access credentials to obtain a hash result;
decrypting a root key using the has result;
comparing a hash value to ensure the root key was properly decrypted; and
unlocking one or more portions of the client system protected by the third party component in response to authentication of the forwarded authenticated user access credentials using the locally stored third-party credentials.

2. The method of claim 1, further comprising, in response to a failure to authenticate the forwarded authenticated user access credentials in the first attempt to authenticate, synchronizing add-on authentication credentials with the forwarded authenticated user access credentials, without user notification or additional user input, through communication with the add-on authentication server by the add-on authentication client.

3. The method claim 2, further comprising:
sending a credential challenge to the add-on authentication server;
generating from the credential challenge a credential response;
sending the credential response to the add-on authentication client;
attempting to verify the credential response at the add-on authentication client; and
unlocking one or more portions of the client system protected by the third party component through the add-on authentication client in response to verification of the credential response by the add-on authentication client.

4. The method of claim 3, further comprising creating, at the add-on authentication client, the credential challenge from a root key associated with one or more of a device identification and user identification.

5. The method of claim 3, further comprising:
retrieving, at the add-on authentication server, a root key associated with at least one of a device identification or user identification provided by the add-on authentication client; and
generating the credential response from the retrieved root key and a challenge code provided by the add-on authentication client.

6. The method of claim 3, further comprising generating and storing a challenge code at initialization of the add-on authentication client and following at least a first usage of the credential challenge or credential response.

7. The method of claim 1, further comprising establishing a shared secret between the add-on authentication server and at least one add-on authentication client associated one or more third party components operable to protect at least a portion of the client system.

8. The method of claim 3, further comprising:
in response to a failure to authenticate the forwarded authenticated user provided access credentials in the first attempt to authenticate, assuming the forwarded authenticated user provided access credentials include updated user access credentials; and
in response to successful verification of the credential response, storing the updated user access credentials for use by the add-on authentication client during subsequent user access attempts.

9. A system, comprising:
at least one microprocessor;
at least one memory operably associated with the at least one processor;
a communications interface operably associated with the at least one processor and operable to exchange information through one or more communications media; and an add-on authentication client storable in the memory and executable in the processor, the add-on authentication client operable to receive user access credentials authenticated by an existing authentication client, attempt to authenticate the received user access credentials with at least one of an add-on authentication server or cached user accessed credentials, unlock one or more portions of the system protected by an associated third party component, in response to authentication of the user access credentials with at least one of the add-on authentication server or the cached credentials, send a credential challenge to the add-on authentication server in response to a failure to authenticate the received user access credentials, receive a credential response, attempt to authenticate the credential response, and unlock a portion of the system protected by the associated third party component upon authentication of the credential response.

10. The system of claim 9, further comprising the add-on authentication client operable to update one or more user access credentials maintained by the add-on authentication client.

11. The system of claim 9, further comprising the add-on authentication client operable to:
assume the user access credentials authenticated by the existing authentication client but which cannot be authenticated by the add-on authentication client without sending a credential challenge to the add-on authentication server are updated user access credentials; and
update one or more user access credentials accessible by the add-on authentication client in response to authentication of the credential response.

12. The system of claim 9, further comprising the add-on authentication client operable to:
receive a user access credential update notification from the existing authentication client;
receive updated user access credentials;
challenge the received updated user access credentials with the existing authentication server; and
update one or more user access credentials accessible by the add-on authentication client upon completing a successful challenge.

13. A method for secure transparent continuously synchronized credentials in an arbitrary third party system, comprising:
receiving a credential update notification;
retrieving a challenge code and a device identification;
sending the challenge code and device identification to a credential and authentication manager;
retrieving an encrypted root key associated with the device identification;
generating a response code using the challenge code and root key;
transmitting the response code to a client credential and authentication manager;
verifying correctness of the response code by successfully decrypting the root key associated with the device identification; and
updating the one or more access credentials.

14. A method for maintaining synchronization between user access credentials required by an existing authentication client and an add-on authentication client without user intervention or notification, comprising:
receiving at the add-on authentication client one or more user access credentials authenticated by at least one of an existing authentication client or an existing authentication server;
attempting to authenticate the user access credentials at the add-on authentication client;
conducting a challenge with an add-on authentication server communicatively associated with the add-on authentication client in response to a failure to authenticate the user access credentials by the add-on authentication client; and
updating one or more user access credentials accessible by the add-on authentication client upon successfully completing the challenge with the add-on authentication server.
